(19) United States
(12) Patent Application Publication
(10) Pub. No.: US 2025/0278319 A1
(43) Pub. Date: Sep. 4, 2025

(54) UNIFORM API FOR WRITING AND METADATA BROWSING

(71) Applicant: SAP SE, Walldorf (DE)

(72) Inventors: Christian SCHMITZ, Porto Alegre (BR); Peter SCHOENAU, Untergruppenbach (DE); Silvio NORMEY GOMEZ, Santana do Livramento (BR); Mitch GUDMUNDSON, Colorado Springs, CO (US)

(21) Appl. No.: 18/800,508

(22) Filed: Aug. 12, 2024

Related U.S. Application Data
(60) Provisional application No. 63/560,189, filed on Mar. 1, 2024.

(51) Int. Cl. G06F 9/54

(52) U.S. Cl. CPC G06F 9/544

(57) ABSTRACT

Systems and methods include reception of a first call to a first interface at a first connector associated with a first data system, the first call requesting to write first data to the first data system and conforming to a data model, conversion, at the first connector, of the first call to a first data model of the first data system, transmission of the converted first call from the first connector to the first data system, reception of a second call to the first interface at a second connector associated with a second data system, the second call requesting to write second data to the second data system and conforming to the data model, conversion, at the second connector, of the second call to a second data model of the second data system, and transmission of the converted second call from the second connector to the second data system.

### CROSS-REFERENCE TO RELATED APPLICATIONS

The present application claims priority to and the benefit of U.S. Provisional Patent Application No. 63/560,189, filed Mar. 1, 2024, under 35 U.S.C. § 119(e). The contents of U.S. Provisional Patent Application No. 63/560,189 are incorporated herein for all purposes.

### BACKGROUND

Modern organizations generate, process and store vast amounts of data. This data may be stored in various data stores and accessed by various applications. Different data stores are differently suited for storing different types of data. Moreover, a given application may use different types of data associated with different requirements.

The particular data stores in which data of an application are stored may be selected based on many factors, including but not limited to a desired redundancy, a desired accessibility, a desired processing speed, and a desired security protocol. Due to these considerations, application data may be stored across multiple databases, file storages, file systems, and external data sources such as third-party vendors, cloud services, and cloud databases.

The diversity of data stores increases the complexity of data integration. For example, the more types of data stores which are used within an application landscape, the more difficult it is to allow clients to generically browse and retrieve metadata of any given data store. Similarly, the more types of data stores which require client access, the more difficult it is to write data sent by a client to any given data store.

### BRIEF DESCRIPTION OF THE DRAWINGS

FIG. 1 illustrates a framework for connecting to disparate data systems according to some embodiments.

FIG. 2 illustrates relationships between batches, data chunks and record batches according to some embodiments.

FIG. 3 is a sequence diagram illustrating a successful write execution message exchange according to some embodiments.

FIG. 4 is a sequence diagram illustrating a failed write execution message exchange according to some embodiments.

FIG. 5 is a sequence diagram illustrating a timed-out write execution message exchange according to some embodiments.

FIG. 6 illustrates clusters providing implementing components of a framework for connecting to data systems according to some embodiments.

FIG. 7 illustrates a hardware implementation of a cluster-implemented framework according to some embodiments.

### DETAILED DESCRIPTION

Embodiments may provide scalable, resilient, observable, extensible, and high-performance connectivity with disparate data systems. Embodiments may support a well-defined and parametrizable Application Programming Interface (API) for communication with each data system. The API may be based on a standardized metadata definition usable to drive user interface (UI) dialogs as well as other system services.

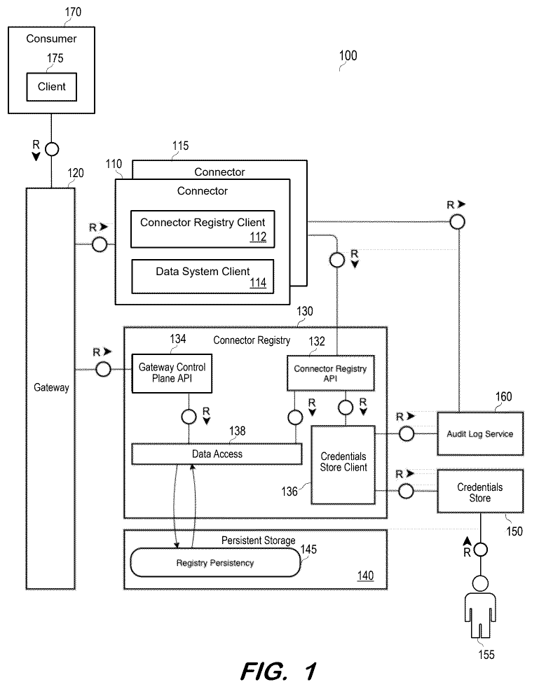

FIG. 1 illustrates landscape 100 according to some embodiments. Landscape 100 may comprise any number of hardware and software components which provide functionality to one or more users (not shown). The components may be implemented using any suitable combinations of computing hardware and/or software that are or become known. Such combinations may include on-premise servers, cloud-based servers, and/or elastically-allocated virtual machines. In some embodiments, two or more components are implemented by a single computing device.

Landscape 100 comprises connectors 110 and 115, which provide integration with data and metadata stored by data systems of different connection and endpoint types. Examples of connection types include but are not limited to ABAP, Google BigQuery, and S4/HANA Cloud, and examples of endpoint types include but are not limited to Web Socket RFC (WSRFC), RFC, and Content Distribution Internetworking (CDI). Consumer 170 sends API calls for accessing metadata and data of a data system of a particular connection type and endpoint type and gateway 120 routes the API calls to a connector corresponding to the connection type, endpoint type and tenant.

Connector registry 130 provides gateway 120 with routing information used for such routing. Connector registry 130 also provides connection details to deployed connectors 110 and 115. Connection details may include information needed to connect to a data system, such as hostname, port, username, password, certificates, etc. Connector registry 130 may also manage connector registration and notify connectors 110, 115 of connection detail updates and connection invalidations.

Embodiments may implement any number of connectors, each of which is associated with a respective connection type, endpoint type and tenant. A connector implements logic for reading and writing data and metadata from and to a data system instance of the connection type and endpoint type with which the connector is associated. Each connector 110, 115 implements and exposes the same well-defined and parametrizable connector API based on a standardized data model, or schema. The data model is capable of describing the distinct structures stored by target data systems. Each connector 110, 115 uses the data model to translate the structures from the native target data system to the standardized data model. The data model defines the structures of the input parameters and outputs for the connector API.

Implementation of the connector API and the other processes described herein may be performed using any suitable combination of hardware and software. Program code implementing APIs and processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture.

Any consumer such as consumer 170 may call the connector API to interact with a data system via a connector. Consumer 170 may comprise a computing device which uses client component 175 to communicate with gateway 120 via the connector API. Client component 175 may encapsulate the communication and actions between consumer 170 and gateway 120. Client component 175 may be tasked with managing gRPC connections, checking health status of connectors and gateway 120, security, resilience, and other aspects.

For example, consumer 170 may send API calls to read and write data, browse and retrieve metadata, and modify data definitions of a data system associated with a connection type and endpoint type. Based on its routing configuration, gateway 120 determines that the calls should be routed to connector 110 and routes the calls thereto. Connector 110 converts the calls from the standardized data model of connectors 110, 115 to a data model of the data system and data system client 114 transmits the calls to the data system using connection details received from connector registry 130. Similarly, data system client 114 may receive responses from the data system and connector 110 may convert the responses from the data model of the data system to the data model of connectors 110, 115 prior to returning the responses to consumer 170 via gateway 120. According to some embodiments, conversion of the responses from the data model of the data system includes translation of target data system model objects into one of the following types: 1) table, 2) view, 3) file, 4) container, 5) function, and 6) unbound dataset. Also, in some embodiments, conversion includes conversion of object properties data types into a standard data type system, such as but not limited to Apache Arrow.

A connector may provide consumer 170 with information specifying its characteristics and capabilities. For example, consumer 170 may transmit a request to gateway 120 requesting capabilities associated with a particular connection type and endpoint type. Connectors 110, 115 may conform to a capability model which obliges a consumer to send commands to read or write data within the set of operations delimited by the connector's capabilities.

According to some embodiments, each connector 110, 115 is a separate microservice that exposes and implements the connector API. Each microservice (i.e., connector) may be provided by a plurality of pods executing connector instances in one or more nodes of a container orchestration system as is known in the art. Landscape 100 may be a cloud-native and decoupled architecture in which gateway 120 and connector registry 130 each also comprise separate microservices implemented by a respective one or more nodes. Consequently and advantageously, each of connectors 110, 115, gateway 120 and connector registry 130 may scale elastically (e.g., by adding/deleting pods and/or nodes) according to their respective workloads. All microservices described herein may communicate with one another and with other unshown microservices using lightweight network communication mechanisms such as a resource API via Hyper Text Transfer Protocol (HTTP) request-response messages, but embodiments are not limited thereto.

According to some embodiments, landscape 100 uses a protocol such as but not limited to gRPC for communication among the components, an interface description language for message, service, and API definitions such as, but not limited to Protocol Buffers, and a standard data type system also used as wire format such as, but not limited to, Apache Arrow. Connectors 110, 115, gateway 120 and registry 130 may execute an application server that runs and operates applications on Kubernetes.

Connector registry 130 comprises connector registry API 132, gateway control plane API 134, and credentials store client 136. Connector registry API 132 may comprise a bi-directional gRPC API. During bootstrapping, connector registry client 112 of connector 110 invokes connector registry API 132 to register its information with connector registry 130. The information may include, for example, connector ID, connector version, configuration, connection type, endpoint type, and supported tenants. Connector registry API 132 calls data access object 138 to persist the connector-specific information in registry persistency 145 of persistent storage 140. Registry persistency 145 may synchronize with the infrastructure layer of landscape 100 to also maintain a list of the available instances (e.g., running pods) for each registered connector.

Connector registry API 132 provides RPCs for connectors to retrieve credentials store connection details from credentials store client 136. Credentials store client 136 connects to credentials store component 150 to obtain connection details such as hostname, port, username, and password associated with a connection ID. Connection details may also include certificates and connector-specific drivers.

Due to the sensitivity of connection details, credentials store component 150 may comprise a secure persistent storage system. User 155 (e.g., a tenant administrator) accesses credentials store component 150 to store connection details for data systems to which the user has access. For example, each data system (and the connection details thereof) may be associated with a connection ID within credentials store component 150.

Gateway control plane API 134 provides routing information to gateway 120. Gateway 120 caches the routing information and uses the routing information to route incoming requests to appropriate connectors. Gateway 120 routes incoming requests to connectors based on connection information (e.g., connection ID, connection type, endpoint type, tenant) specified by the requests. Routing may be based on other types of information specified in a request. Gateway 120 may comprise an L7 load balancer that supports HTTP/2 and connections multiplexing, which allows the reuse of the same TCP socket for multiple HTTP connections.

Gateway 120 can survive outages of gateway control plane API 134 using cached routing information, at least until the routing information stored in registry persistency 145 changes. Routing information stored in registry persistency 145 may change due to asynchronous registration or de-registration of connectors. To keep the routing information of gateway 120 up-to-date, gateway 120 may maintain a live gRPC stream to gateway control plane API 134. Accordingly, gateway control plane API 134 may regularly pull routing information from registry persistency 145 of persistent storage 140 via data access object 138 and determine whether any of the routing information has changed. If so, all current routing information (or just the changed routing information) stored in registry persistency 145 is transmitted to gateway 120. According to some embodiments, prior to transmission of the routing information, stored gateway control plane API 134 translates routing information entities corresponding to the connector data model into entities (e.g., clusters, endpoints, listeners, and routes) of the data model of gateway 120.

As mentioned above, gateway 120 may be implemented using multiple instances. When a new instance is deployed, the instance calls gateway control plane API 134 to create a gRPC bi-directional stream and thereafter calls the gateway control plane API 134 to retrieve a routing configuration including all current routing information from registry persistency 145.

According to some embodiments, the connector API includes an Info Service which provides information about a connector, an Object Definition service which provides object management in the target data system, a Metadata Service which provides metadata retrieval methods, a Data Service which provides data reading and writing methods, and a Subscription Service which provides methods for managing subscriptions in the target data system.

In some embodiments, the Data Service includes a Write API which supports Change Data Capture (CDC) writes and non-CDC writes. In a non-CDC write, row batches are sent by the client and expected to be inserted into the target table. In a CDC Write, data changes are sent by the client and expected to be reflected in the target table. The Write API may require acknowledgment of the data transfer (i.e., the row or the data change information) to the remote system and allows for the possibility of retries from the client for sent data that did not successfully commit.

As will be described below, standard “opcodes” may be defined so that connectors know from what opcodes they need to translate. A client may provide an opcode mapping between the client's custom opcodes to the standard opcodes and let the connector handle the translation from the client's custom opcodes to the standard opcodes. Clients may explicitly define which column of a row includes the opcodes.

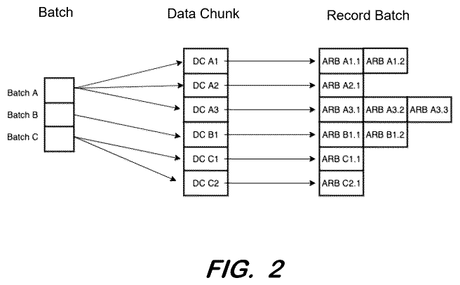

FIG. 2 illustrates relationships between batches, a data chunks and record batches for the purpose of explaining write execution according to some embodiments. A batch is a package of data which must be flushed together. A batch_id (e.g., A, B, C) is an identifier of a batch and is defined and managed by the consumer. A batch can be split into different data chunks. Each write message sent by the consumer to the connector contains exactly one data chunk. Each data chunk contains one or more record batches, such as but not limited to Apache Arrow record batches. In this regard, an Apache Arrow record batch is a structure used in Arrow inter-process communication (IPC) to represent a set of rows of a dataset.

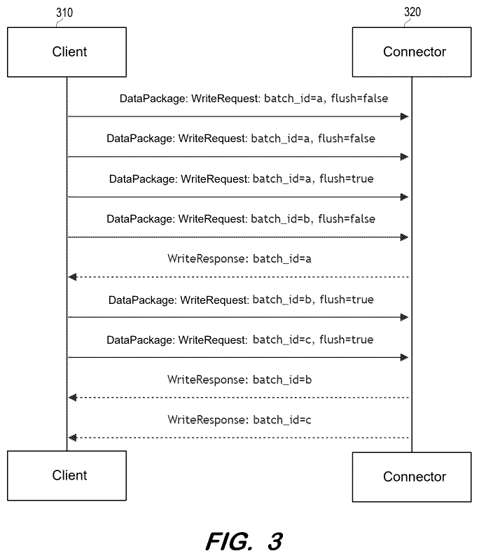

FIG. 3 is a sequence diagram illustrating a successful write execution message exchange according to some embodiments. Client 310 transmits a stream of messages for a data system which is received by connector 320. To avoid resource exhaustion from a single stream, connectors may use HTTP/2's Flow Control mechanism to allow for blocking new write requests until resources have been freed up.

Each write message corresponds to one batch. A batch is associated with 1. . . . N write messages, with each of the N write messages including a data chunk of the batch. The flush indicator of a last-transmitted write message of a batch is set to true. Flushing is intended to make the changes of the batch visible in the data system. Prior to flushing, the changed data is not yet accessible or is otherwise designated as “dirty”.

Connector 320 returns a stream of write response messages in response to the stream of incoming messages. Each write response message indicates a successful flush of a batch. Connector 320 follows the ordering of the received flush requests (e.g., for the FIG. 3 scenario, batch_id=c may be flushed to the target data system only after batch_id=b is successfully flushed).

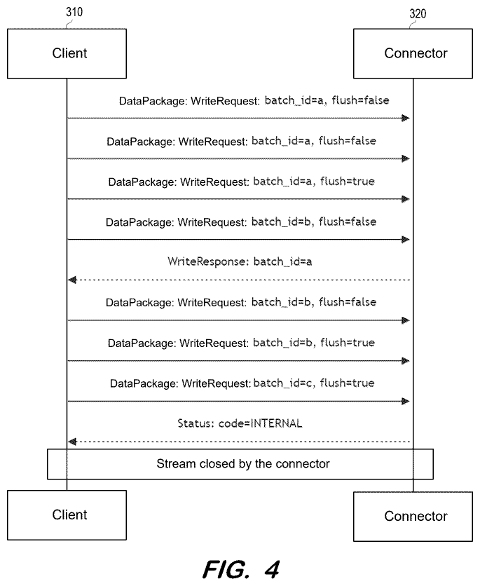

FIG. 4 is a sequence diagram illustrating a failed write execution message exchange according to some embodiments. As shown, client 310 transmits a write message corresponding to batch_id=b and with a flush indicator set to true. Then, before connector 320 has returned a write response message indicating a successful flush of batch_id=b, client 310 transmits a write message corresponding to batch_id=c and with a flush indicator set to true.

Due to this error condition, connector 320 stops the RPC, returns an error message, closes the stream, and stops processing any write requests from that RPC which are queued in connector 320 (e.g., rolling back transactions, removing temporary and unflushed data). Consequently, connector 320 may free up any buffered data from its memory. In some embodiments, no recovery will be available within a batch. Rather, to resume a failed write execution message exchange, client 310 must open a new stream and resume from batch_id=(last-flushed batch_id+1).

A special write message is always sent when opening a stream of write messages. This message contains extra metadata, such as the target table to which to write. Sending a write message with this extra metadata in the middle of the stream is not allowed and causes the write operation to fail. In addition, sending write messages with a new batch id without a flush indicator being received for the previous batch is not allowed (i.e., sending interleaved messages for data of batch_id=a and data of batch_id=b is not permitted).

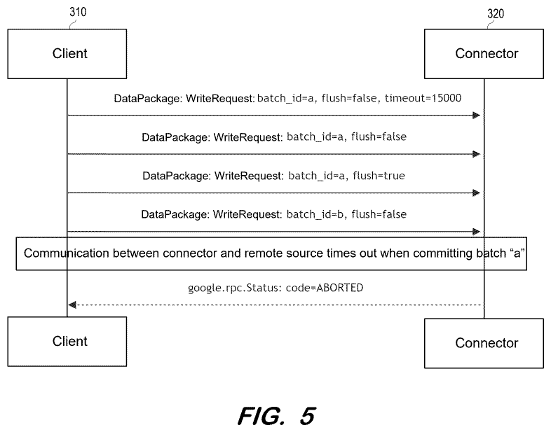

As shown in FIG. 5, client 310 may pass a value of an optional timeout parameter. Connector 320 uses a default timeout value if client 310 does not pass the timeout parameter value. FIG. 5 is a sequence diagram illustrating a timed-out write execution message exchange according to some embodiments. In response to a timeout of the write of batch_id=a in connector 320, connector 320 stops the RPC and returns a corresponding status code (e.g., ABORTED).

The Write API assumes the target data system is created and available for writing. A connector must be able to create a file when receiving the first WriteControl message for that file using the received schema. The schema of a batch sent to the connector must match the schema of the target data system. Options for file creation can be passed between client and connector via custom parameters.

According to some embodiments, the Write API does not contain any method of creating/dropping tables, views, containers, remote functions/procedures nor unbound datasets. Such methods may be provided by a Data Description Language (DDL) API.

For a CDC Write, a client indicates a change mode associated with a row. Each possible change mode may be indicated by a predetermined opcode, such as I=Insert, D=Delete, U=Update, A=Upsert, M=Archive Delete. A mapping may be provided to translate client-supplied opcodes to the default opcodes. A connector may expect that the ordering within a batch is not necessarily preserved when writing, so all Deletes/Inserts/Updates contained in one batch may be executed as bulk actions.

The connector may decide whether a CDC Write will be history-preserving (i.e., persisting the change-modes on the target data system) or not (i.e., creating Data Manipulation Language (DML) commands that will reflect the CDC Write in the target data system). A connector may define a custom parameter allowing the client to select between the two (and/or other) options.

A connector may define a Maximum Receive Message Size which will allow gRPC to fail write messages which are bigger than the connector allows. The Maximum Receive Message Size may be exposed by the connector as part of the Info Service.

From time to time, the HTTP/2 connection may be closed to allow resource redistribution (load balancing). The timing of these closures can be set by a connector via gRPC's GRPC_ARG_MAX_CONNECTION_AGE_MS and

GRPC_ARG_MAX_CONNECTION_AGE_GRACE_MS parameters. In some scenarios, the values of these parameters are small (e.g., 3 min for connection age and 30 s for grace period).

The following pseudocode represents a non-exhaustive example of a Write API according to some embodiments:

```
message WriteRequest {
  //*Control Message provides additional meta information on how to
handle the connector operation
  oneof metadata {
    WriteStartControl write_start_control
    WriteControl write_control
  }
  // binary data serialized.
  bytes payload
}
message WriteStartControl {
  WriteStartParameters start_parameters
  WriteControl write_control
}
message WriteControl {
  string batch_id
  bool flush
}
message WriteStartParameters {
  string target_unified_name
  optional int32 timeout_seconds
  // only needed for cdc write
  // only needed in first request from batch
  optional ReplicationParameters replication_parameters
  optional Configuration custom_config
        // connector can allow for custom customer-specified
configurations specific to the connector
}
message ReplicationParameters {
  string change_mode_column_name = 1
  // optional - only needed for cdc write when client does not
translate custom change modes to standard change modes
  map<string, ChangeMode>
  custom_to_standard_change_modes_mapping
}
enum ChangeMode {
  CHANGE_MODE_UNSPECIFIED = 0;
  CHANGE_MODE_INSERT // Maps to “I” column value
  CHANGE_MODE_UPDATE // Maps to “B” column value
  CHANGE_MODE_UPSERT // Maps to “A” column value
  CHANGE_MODE_DELETE // Maps to “D” column value
  CHANGE_MODE_ARCHIVE // Maps to “M” column value
}
message WriteResponse {
  string batch_id
  optional ProcessingDiagnostics diagnostics
      // for returning diagnostics information such as time spent by
calling the remote system, time spent translating the request to the
remote system dialect, etc.
}
```

The Metadata Service of the connector API provides a Metadata API for browsing and retrieving metadata of various data systems. The Metadata API may rely on an API-centric name which is provided for all objects returned from browsing and metadata. This name may be used to understand where an object resides in a hierarchy.

Each connector may also incorporate a native-centric name which is provided for all objects returned from browsing/retrieving and which can be used for any native references (e.g., in SQL statements). This native-centric name may be created by a connector in a connector-specific manner and may follow any standard.

A connector also provides a display-centric name for all objects which allows for a presentation layer to provide a readable name. The display-centric name may follow any protocol determined by a connector and should be consistent and readable (e.g., tab″le).

According to some embodiments, for metadata browsing, the input message to the browsing endpoint contains the unified name, an optional string for the search expression, an optional number of elements to skip, an optional list of node types to match, a boolean to control recursive (i.e. all items in the tree including and below the given 1) or hierarchical (i.e., level-by-level) browsing, and an optional fetch size which provides a hint to the connector and a limit to the maximum allowed items per message.

If unifiedName is empty, the input message will be treated as browsing the root, or semantically as if unifiedName was ‘/’. According to some embodiments, the search string must be a valid Glob pattern. If a number of elements to skip is provided, the number is applied after all other filtering. In recursive browsing, all leaf and non-leaf nodes are returned by default and the connector may return results in a depth-first search order. If only ‘leaf’ nodes are desired, then the input message should list this node type.

The connector will stream one or more messages back to the client with browsing results. A response message contains a list of browsed objects matching the specified criteria. The size of the list should be no more than the specified fetch size.

According to some embodiments, for metadata retrieval, the input message to the metadata retrieval endpoint contains the unified name and an optional list of DatasetParameter objects. The caller is able to change any DatasetParameter objects which are returned, potentially altering subsequent calls. Unlike browsing, metadata retrieval follows a 1:1 request/response (i.e., no streaming) pattern.

The following is a non-exhaustive example of a Metadata API according to some embodiments, defined using Protocol Buffers interface description language.

```
enum NodeType {
  NODE_TYPE_TABLE
  NODE_TYPE_VIEW
  NODE_TYPE_FILE
  NODE_TYPE_OBJECT /* General object */
  NODE_TYPE_CONTAINER /* i.e. schema (DB) or folder/bucket
(file system) */
  NODE_TYPE_FUNCTION
  NODE_TYPE_UNBOUND /* an object that only delivers an endless
stream of data and does not allow bound access */
}
message MetadataDiagnostics {
  ProcessingDiagnostics processing_diagnostics = 1;
}
message DatasetParameter {
  string name
  ParamType type
  ParameterValue param
  repeated string possible_vals /* helpful to drive UI */
}
message ListNodesRequest {
  string unified_name
  /* object glob search pattern i.e. “my*.csv” or “MY_*_TABLE” */
  optional string search
  optional int32 skip
  /* recursively search entire ‘tree’ from <absolutePathName>
location */
  bool recursive
  /* If specified, only types of matchTypes will be returned */
  repeated NodeType match_types
  /* Provides a max and a hint for message size desired. * /
  optional int32 fetch_size
  optional custom_config
      // for each endpoint, the consumer may pass arbitrary
      configurations that to that connector type. The connector
      exposes the supported custom configurations upon registration
      in the connector registry
}
message ListNodesResponse {
  string unified_name
  // whether content can be created within the node
  optional bool allows_child_creation
  repeated NodeInfo nodes
  optional MetadataDiagnostics info
}
message NodeInfo {
  string display_name
  string unified_name
  string native_name
  NodeType node_type
  optional SizeInfo size
  LocalizedDescriptionList descriptions
  bool can_list
}
message GetMetadataRequest {
  string unified_name
  repeated DatasetParameter data_access_params
  FieldMask field_mask
  // allows the consumer to define the set of fields from the
response that it requires
  optional custom_config
}
message GetMetadataResponse {
  /* Simple name, no encoding, as shown in source */
  string display_name
  string unified_name
  string native_name
  string native_type
  NodeType node_type
  /*
      Extra parameters needed for acessing a specific object.
      One example would be view parameter value handling.
  */
  repeated DatasetParameter data_access_params
  optional LocalizedDescriptionList descriptions
  repeated PropertyWithNamespace properties
  // metadata specific to an object type
  ObjectMetadata object_metadata
  optional SizeInfo size
  optional VersionInfo version
  optional MetadataDiagnostics diagnostics
  // for returning diagnostics information such as time spent by
calling the remote system, time spent translating the request to the
remote system dialect, etc.
}
message ObjectMetadata {
  oneof object_metadata {
    TableMetadata table_metadata
    ViewMetadata view_metadata
    FileMetadata file_metadata
    ContainerMetadata container_metadata
    UnboundDatasetMetadata unbound_dataset_metadata
  }
}
message TableMetadata {
  optional Schema schema
  /* Capabilities that define what the connector and remote system
allows to be done with the table */
  optional TableCapabilities table_capabilities
  optional PrimaryKey primary_key
  repeated ForeignKey foreign_keys
  repeated PhysicalPartitionInfo partitions
}
message ViewMetadata {
  optional Schema schema
  optional TableCapabilities table_capabilities
}
message FileMetadata {
  optional Schema schema
  optional TableCapabilities table_capabilities
}
message ContainerMetadata {
  // whether content can be created within the container
  bool allows_child_creation
}
message UnboundDatasetMetadata {
  optional Schema schema
}
```

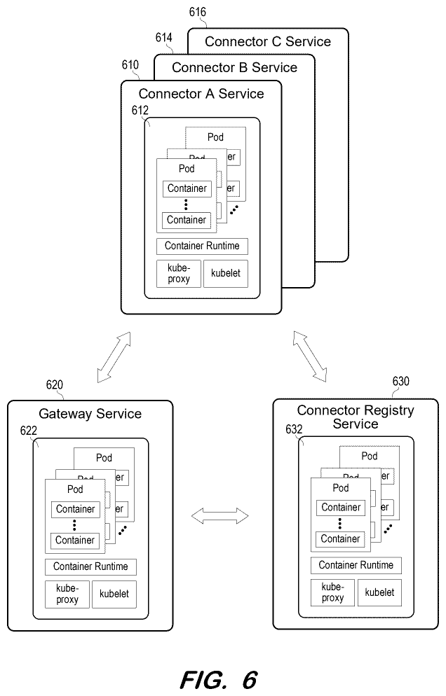

FIG. 6 illustrates implementations of connectors 610, 614 and 616, gateway 620 and connector registry 630 according to some embodiments. Each of services 610, 614, 616, 620 and 630 may be implemented by a plurality of pods of a container orchestration platform such as but not limited to Kubernetes. As such, each service may include a node executing several pods, in which each pod executes a separate instance of the service. Each node 612, 622 and 632 is a virtual or physical machine including kubelet for node and container management, kube-proxy for a network proxy, and a container runtime (e.g., Docker) to run container.

Although FIG. 6 illustrates one node 612, 622 and 632 per service, any service may include any number of nodes, each executing its own set of one or more pods. A master node (not shown) of each service may adjust the number of pods, the number of nodes and/or the computing resources of each node as desired. The adjustment may be based on expected workload or any other factors. For example, if an expected workload is greater than a first threshold, one or more additional pods are created. If the expected workload is less than a second threshold, one or more of pods are terminated.

Accordingly, each of connector services 610, 614, 616 may be implemented by several connector instances and connector registry service 630 may be implemented by several connector registry instances, in which all instances execute independently and in parallel. If a connector registry client of a connector instance registers its connector information using a connector registry API of a connector registry instance, all other connector registry instances will initially be unaware of the registration. Accordingly, to establish a consistent state of connection information throughout the landscape, each running connector registry instance may periodically read the connection information from shared persistent storage and push the connection information to the gateway instance(s) to which it is connected.

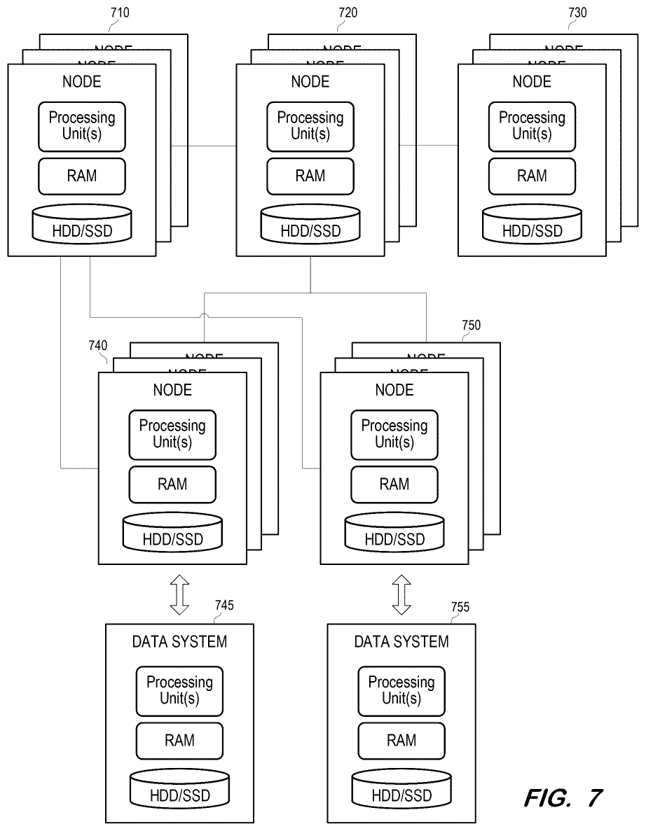

FIG. 7 illustrates a cloud-based deployment according to some embodiments. The illustrated components may comprise cloud-based resources residing in one or more public or private clouds providing self-service and immediate provisioning, autoscaling, security, compliance and identity management features.

Each illustrated node may comprise a physical or virtual machine of a container orchestration platform cluster. Nodes 710 may execute instances of a gateway while nodes 720 may execute instances of a connector registry. Nodes 730 may comprise a database service for storing connector-specific connection information. Nodes 740 may execute instances of a first connector implementing a connector API as described herein and nodes 750 may execute instances of a second connector implementing the connector API. The instances of the first connector may communicate with data system 745 and the instances of the second connector may communicate with data system 755.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of networks and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a first computing system comprising:
a first memory storing first program code;
a first one or more processing units to execute the first program code to cause the first computing system to:
receive a first call to a first application programming interface, the first call requesting to write first data to a first data system, the first call conforming to a data model;
convert the first call to a first data model of the first data system; and
transmit the converted first call to the first data system; and
a second computing system comprising:
a second memory storing second program code;
a second one or more processing units to execute the second program code to cause the second computing system to:
receive a second call to the first application programming interface, the second call requesting to write second data to a second data system, the second call conforming to the data model;
convert the second call to a second data model of the second data system, where the second data model is different from the first data model; and
transmit the converted second call to the second data system.

2. The system of claim 1, the first one or more processing units to execute the first program code to cause the first computing system to:
receive a first response to the first call from the first data system;
convert the first response from the first data model to the data model; and
return the converted first response; and
the second one or more processing units to execute the first program code to cause the first computing system to:
receive a second response to the second call from the second data system;
convert the second response from the second data model to the data model; and
return the converted second response.

3. The system of claim 2, the first one or more processing units to execute the first program code to cause the first computing system to:
receive a third call to a second application programming interface, the third call requesting to browse metadata of the first data system; and
the second one or more processing units to execute the second program code to cause the second computing system to:
receive a fourth call to the second application programming interface, the fourth call requesting to browse metadata of the second data system.

4. The system of claim 3, wherein the third call comprises a first search expression, a first number of elements to skip, and a first list of node types, and
wherein the fourth call comprises a second search expression, a second number of elements to skip, and a second list of node types.

5. The system of claim 4, wherein the third call comprises a first indicator of recursive or hierarchical browsing and a first fetch size, and
wherein the fourth call comprises a second indicator of recursive or hierarchical browsing and a second fetch size.

6. The system of claim 1, the first one or more processing units to execute the first program code to cause the first computing system to:
receive a third call to a second application programming interface, the third call requesting to browse metadata of the first data system; and
the second one or more processing units to execute the second program code to cause the second computing system to:
receive a fourth call to the second application programming interface, the fourth call requesting to browse metadata of the second data system.

7. The system of claim 6, wherein the third call comprises a first search expression, a first number of elements to skip, a first list of node types, a first indicator of recursive or hierarchical browsing and a first fetch size, and
wherein the fourth call comprises a second search expression, a second number of elements to skip, a second list of node types, a second indicator of recursive or hierarchical browsing and a second fetch size.

8. A method comprising:
receiving a first call to a first application programming interface at a first connector associated with a first data system, the first call requesting to write first data to the first data system and conforming to a data model;
converting, at the first connector, the first call to a first data model of the first data system;
transmitting the converted first call from the first connector to the first data system;
receiving a second call to the first application programming interface at a second connector associated with a second data system, the second call requesting to write second data to the second data system and conforming to the data model;
converting, at the second connector, the second call to a second data model of the second data system;
transmitting the converted second call from the second connector to the second data system.

9. The method of claim 8, further comprising:
receiving, at the first connector, a first response to the first call from the first data system;
converting, at the first connector, the first response from the first data model to the data model;
returning the converted first response from the first connector in response to the first call;
receiving, at the second connector, a second response to the second call from the second data system;
converting, at the second connector, the second response from the second data model to the data model; and
returning the converted second response at the second connector in response to the second call.

10. The method of claim 9, further comprising:
receiving a third call to a second application programming interface at the first connector, the third call requesting to browse metadata of the first data system; and
receiving a fourth call to the second application programming interface at the second connector, the fourth call requesting to browse metadata of the second data system.

11. The method of claim 10, wherein the third call comprises a first search expression, a and a first list of node types, and
wherein the fourth call comprises a second search expression, and a second list of node types.

12. The method of claim 11, wherein the third call comprises a first fetch size, and wherein the fourth call comprises a second fetch size.

13. The method of claim 8, further comprising:
receiving a third call to a second application programming interface at the first connector, the third call requesting to browse metadata of the first data system; and
receiving a fourth call to the second application programming interface at the second connector, the fourth call requesting to browse metadata of the second data system.

14. The method of claim 13, wherein the third call comprises a first search expression, a first list of node types, and a first indicator of recursive or hierarchical browsing, and
wherein the fourth call comprises a second search expression, a second list of node types, and a second indicator of recursive or hierarchical browsing.

15. One or more non-transitory computer-readable media storing program code that, when executed by a computing system, causes the computing system to perform operations comprising:
receiving a first call to a first application programming interface, the first call requesting to write first data to a first data system, the first call conforming to a data model;
converting the first call to a first data model of the first data system; and
transmitting the converted first call to the first data system;
receiving a first response to the first call from the first data system;
converting the first response from the first data model to the data model; and
receiving a second call to the first application programming interface, the second call requesting to browse metadata of the first data system.

16. The one or more non-transitory computer-readable media of claim 15, wherein the second call comprises a search expression and a list of node types.

17. The one or more non-transitory computer-readable media of claim 16, wherein the second call comprises an indicator of recursive or hierarchical browsing and a fetch size.

18. The one or more non-transitory computer-readable media of claim 17, wherein the first data is associated with a data batch, and wherein the program code, when executed by a computing system, causes the computing system to perform operations comprising:
receiving a third call to the first application programming interface, the third call requesting to write second data associated with the data batch to the first data system, the first call conforming to the data model and including an instruction to flush the second data to the first data system;
after receiving the third call, determining that an instruction to flush the first data to the first data system has not been received; and
in response to determining that an instruction to flush the first data to the first data system has not been received, returning an error in response to the third call.

19. The one or more non-transitory computer-readable media of claim 15, wherein the first data is associated with a data batch, and wherein the program code, when executed by a computing system, causes the computing system to perform operations comprising:
receiving a third call to the first application programming interface, the third call requesting to write second data associated with the data batch to the first data system, the third call conforming to the data model;
receiving a fourth call to the first application programming interface, the fourth call requesting to write third data associated with a second data batch to the first data system, the fourth call conforming to the data model.

20. The one or more non-transitory computer-readable media of claim 15, wherein the first data is associated with a data batch, and wherein the program code, when executed by a computing system, causes the computing system to perform operations comprising:
receiving a third call to the first application programming interface, the third call requesting to write second data associated with the data batch to the first data system, the first call conforming to the data model and including an instruction to flush the second data to the first data system;
after receiving the third call, determining that an instruction to flush the first data to the first data system has not been received; and
in response to determining that an instruction to flush the first data to the first data system has not been received, returning an error in response to the third call.
